(19) United States
(12) Patent Application Publication
(10) Pub. No.: US 2026/0338291 A1
(43) Pub. Date: Oct. 29, 2026

(54) Valve Drive Device

(71) Applicant: ECO HOLDING 1 GMBH, Marktheidenfeld (DE)

(72) Inventors: Dieter Maisch, Kohlberg (DE); Hartmut Weber, Altdorf (DE)

(73) Assignee: ECO HOLDING 1 GMBH, Marktheidenfeld (DE)

(21) Appl. No.: 19/103,989

(22) PCT Filed: Aug. 8, 2023
(86) PCT No.: PCT/EP2023/071915

§ 371 Date: Feb. 14, 2025

(30) Foreign Application Priority Data
Aug. 18, 2022 (DE) 10 2022 120 844.3
Nov. 30, 2022 (DE) 10 2022 131 755.2
Nov. 30, 2023 (DE) 10 2023 104 499.0

(51) Int. Cl. F16K 31/04; F16K 1/32

(52) U.S. Cl. CPC F16K 31/047; F16K 1/32

(57) ABSTRACT

A valve drive device includes a base element, a lifting rod for driving a valve body, wherein the lifting rod is movable in terms of translation and without rotation relative to the base element along its longitudinal axis between a first end position and a second end position different from the first end position, a rotor rotatable about the longitudinal axis for driving the lifting rod, wherein a rotational movement of the rotor is transmittable by a transmission device into the translational and non-rotational movement of the lifting rod, and a rotation-limiting device for limiting the rotational movement of the rotor between a first end stop and a second end stop, wherein the lifting rod is in the end position when the rotor has rotated into the first end stop and the lifting rod is in the end position when the rotor has rotated into the second end stop.

### TECHNICAL FIELD

The invention relates to a valve drive device comprising a base element, a lifting rod for driving a valve body, wherein the lifting rod is movable in a translatory and non-rotational manner with respect to the base element along its longitudinal axis between a first end position and a second end position different from the first end position. Furthermore, the valve drive device comprises a rotor rotatable about the longitudinal axis (L) for driving the lifting rod, wherein a rotational movement of the rotor is transmittable by a transmission device into the translatory and non-rotational movement of the lifting rod.

In addition, the present invention relates to a valve for blocking and/or controlling a flow of fluids, wherein the valve comprises a valve body that is configured to be moved between a fully closed position and a fully open position within a valve housing, and a method for manufacturing a valve drive device.

### PRIOR ART

In the prior art, known valve drive devices usually have actuating spindles that are set in rotation by means of a drive. Using a thread, the rotation of the actuating spindle is converted into a translatory movement in order to move a valve body between a closed and an open position. This results in a number of disadvantages. For example, a rotational decoupling needs to be installed between the actuating spindle and the valve body to prevent the actuating spindle and the valve body from jamming in the seal seat in the event of high torque. In order to reduce wear between the actuating spindle and the valve body, at least one sliding disk has to be provided that minimizes the contact surfaces and friction between the actuating spindle and the valve body. Another disadvantage arises from the fact that the actuating spindle, including the rotor, moves in the axial direction relative to the stator. Despite this axial relative movement, the stator is required to be able to transmit a sufficient amount of torque to the rotor.

### DESCRIPTION OF THE INVENTION

The object of the invention is to provide a valve drive device that belongs to the technical field mentioned above and which at least partially overcomes the disadvantages of the prior art. In particular, the object of the present invention is to provide an improved concept for a valve drive device.

The solution to the problem is defined by the features of claim 1. The valve drive device according to the invention comprises a base element, a lifting rod for driving a valve body, wherein the lifting rod is movable between a first end position and a second end position different from the first end position along its longitudinal axis in a translatory and non-rotational manner with respect to the base element. In addition, the valve drive device according to the invention comprises a rotor rotatable about the longitudinal axis for driving the lifting rod, wherein a rotational movement of the rotor is transmittable by a transmission device into the translatory and non-rotational movement of the lifting rod. Furthermore, the valve drive device comprises a rotation-limiting device for limiting the rotational movement of the rotor between a first end stop and a second end stop, wherein the lifting rod is in the first end position when the rotor has rotated into the first end stop and the lifting rod is in the second end position when the rotor has rotated into the second end stop.

This has the technical advantage, for example, that the lifting rod is configured to be movable in a purely translatory and completely rotation-free manner. This means that it is not necessary to provide a rotational decoupling between the valve body and the lifting rod. In addition, a sliding disk is not required because the amount of wear is significantly reduced due to the absence of relative movement between the components. In other words, the operating lifespan of the valve drive device and thus the operating lifespan of the entire valve is extended.

In another embodiment, the rotation-limiting device is arranged at least in portions radially between the lifting rod and the rotor. This has the technical advantage, for example, that the valve drive arrangement and thus the entire valve can be designed to be particularly compact and space-saving.

According to a preferred embodiment, the rotation-limiting device comprises a stop sleeve and a driver, wherein the driver is arranged between the stop sleeve and the rotor, the driver is connected to the rotor in a rotationally fixed and slidably movable manner, and the stop sleeve comprises a guide track for guiding the driver. This has the technical advantage, for example, that the rotation-limiting device defines a movement interval for the rotor, thereby extending the operating time of the valve drive device and thus the operating time of the entire valve. A further technical advantage is that the rotor itself does not move axially relative to the stator. The rotation-limiting device compensates for the axial movement by the driver performing the axial movement. The driver is only movable relative to the rotor in the axial direction. In other words, torque transmission from the rotor to the driver is possible. Thus, torque is transmitted from the stator to the rotor and consequently directly to the driver. The driver is moved by the torque through the guide track of the stop sleeve. The axial movement of the lifting rod is effected by the transmission device, while the rotation-limiting device with the driver and the stop sleeve define the first end position and the second end position of the lifting rod, wherein the rotor always remains in an axially unchanged position. This additionally improves the compact design of the valve drive device and enables optimal torque transmission between stator and rotor. The rotor can thus be designed to be much more compact in the axial direction.

To prevent an axial movement of the rotor, a rotational movement of the rotor causes a rotational movement of the driver around the stop sleeve and the driver is moved within the guide track. This has the technical advantage, for example, that the rotation-limiting device, together with the driver that is slidingly movable in the axial direction and the engagement of the driver in the guide track, causes an immediate relative movement between the driver and the rotor as well as between the driver and the guide track. Thus, no axial movement takes place between the rotor and the stator.

According to a particularly preferred embodiment, the guide track is formed as a helical groove in the stop sleeve and the driver comprises a first projection that is arranged to engage in the helical groove of the stop sleeve. This has the technical advantage, for example, that the driver can slide as smoothly as possible in the guide track via the first projection. The helical design of the guide track enables a regular and continuous movement of the driver in the guide track. This creates a direct and proportional movement relationship between the axial position of the lifting rod and the position of the driver within the guide track. However, in addition, it is also possible to provide the guide track with sections of different slopes. For example, the guide track can be provided with a lower slope in the end sections, which allows a lower starting torque to be realized.

In order to define the fully retracted position of the lifting rod in the sense of a first end stop and the fully extended position of the lifting rod in the sense of a second end stop, the guide track comprises a first guide track end and a second guide track end. The first guide track end defines the first end stop for the rotor and the second guide track end defines the second end stop for the rotor. This has the technical advantage, for example, that a simple and unambiguous movement interval of the lifting rod can be specified. When the first end stop is reached, the valve is fully open, which means that the lifting rod cannot be retracted any further.

When the second end stop is reached, the valve is fully closed, which means that the valve body is completely fitted in the valve seat. The end stops prevent each using a mechanical stop that despite applied torque no further axial movement is possible, thus preventing the components from jamming due to self-locking. Another particular advantage is the simplified adaptability of the valve drive device to set conditions. The stop sleeve can be replaced with little effort, which means that the end stops can also be adapted depending on the application.

According to a further preferred embodiment, the stop sleeve is connected in a rotationally-fixed manner to the base element. Preferably, the stop sleeve is arranged in a non-rotating manner with respect to the base element. This has the technical advantage, for example, that a rotational relative movement between the lifting rod and the stop sleeve is not possible using very simple means. This ensures, on the one hand, the function and, on the other hand, easy assembly of the valve drive device.

According to a particularly preferred embodiment, the lifting rod is arranged in the base element in a rotationally fixed and slidably movable manner. In particular in combination with the previous embodiment, according to which the stop sleeve is also arranged in a rotationally fixed manner with respect to the base element, manufacturing tolerances among the individual components can be compensated and precise positioning of the lifting rod can be achieved.

In order to prevent axial movement of the rotor relative to the stator, the rotor comprises a guiding element, wherein the driver is connected to the rotor via the guiding element in a rotationally fixed and slidably movable manner. This has the technical advantage, for example, that an axial movement force of the rotor is compensated by the driver. For example, the guiding element comprises an axially aligned groove on the inner wall of the rotor. Thus, the driver is movable relative to the rotor exclusively in the longitudinal direction and can slide along the groove on the rotor. This only allows torque to be transmitted from the rotor to the driver, wherein the driver is moved by the torque through the guide track of the stop sleeve. Here, the driver comprises a second projection, which engages in the guide track and can slide largely without friction.

According to a further preferred embodiment, the lifting rod comprises a controlling end in longitudinal direction for controlling the valve body, and the transmission device is arranged at an end of the lifting rod opposite the controlling end. This has the technical advantage, for example, that the controlling end is configured exclusively for the precise transmission of an axial movement to the valve body. For example, the controlling end carries a spring element in order to press the valve body into the valve head bearing with a defined biasing force. The transmission device includes an internal thread which converts the rotational movement of the rotor into a translatory movement of the lifting rod. By arranging the controlling end on the opposite side to the transmission device, a spatial separation is created between the mechanical transmission of rotation to translation and the precise axial positioning of the valve body. This separation simplifies assembly and also reduces wear on the valve body. This increases the service life of the valve drive device.

According to a further particularly preferred embodiment, the lifting rod is mounted such that it can be biased with respect to a valve body to be controlled. This has the technical advantage, for example, that the valve body can be pressed into the valve seat with a defined biasing force. For example, a spring element is mounted between the lifting rod and the valve body. This increases the tightness of the valve and at the same time reduces wear. In addition, jamming or self-locking of the valve body is prevented.

In order to provide a particularly compact and space-saving drive for actuating the valve drive device, the valve drive device comprises a stepper motor, wherein the stepper motor includes a stator and the rotor, and the stator encases the rotor at least in portions and the rotational movement of the rotor is controllable via the stator.

According to a particularly advantageous embodiment, an axial alignment of the stator with respect to the rotor is configured to be invariable during a rotational movement of the rotor between the first end stop and the second end stop. This has the technical advantage, for example, of improving the compact design of the valve drive device and enabling optimal torque transmission between stator and rotor. The rotor can thus be designed to be significantly more compact in the axial direction.

According to a further embodiment, the lifting rod comprises a controlling end in the longitudinal direction for controlling the valve body and the transmission unit is arranged between the controlling end and the stop sleeve. This achieves the technical advantage, for example, that the entire valve drive device can be designed to be more compact in the longitudinal direction. For example, the transmission unit can be designed as an integral part of the lifting rod. Overall, the lifting rod can be designed to be shorter, wherein the lifting rod only needs to be supported at the controlling end. This reduces the manufacturing costs and also reduces the requirements in terms of geometric and tolerance specifications. For example, the transmission device can be formed integrally with the lifting rod.

According to an additional advantageous embodiment, the valve drive device comprises a cover element which is connected to the stop sleeve in a rotationally fixed manner via an engaging portion. This has the technical advantage, for example, that the stop sleeve can be very easily fixed to the cover element and thus fixed in a rotationally fixed manner with respect to the rotor. For example, the engaging portion is designed to be longitudinally movable, thereby enabling tolerance compensation in the longitudinal direction. Overall, the valve drive device can be assembled more easily.

According to an additional embodiment, the rotor is mounted on the base element via a roller bearing. This has the technical advantage, for example, that the rotor is precisely axially and radially mounted and the assembly of the entire valve drive device is significantly simplified. The roller bearing provides the valve drive device with a high degree of stability, which is why there is a reduction in the manufacturing tolerances of all remaining components. Overall, the valve drive device is cheaper to manufacture and easier to assemble and has a bearing with greatly reduced friction.

According to a particularly advantageous embodiment, the valve drive device comprises a deep-drawn cover sleeve that is firmly connected to the base element, wherein the rotor and the rotation-limiting device are preferably completely housed in the cover sleeve. This has the technical advantage, for example, that the valve drive device is sealed off from the outside and protected in the cover sleeve. The deep-drawn cover sleeve is particularly easy to manufacture and easy to assemble.

In order to further simplify the assembly of the valve drive device and to prevent the stop sleeve from rotating during operation of the valve drive device, the cover sleeve comprises a sleeve extension for engaging in the stop sleeve, wherein the sleeve extension is designed to fix the stop sleeve at least in a non-rotatable manner relative to the cover sleeve. The fixed connection of the cover sleeve to the base part indirectly ensures rotation prevention of the cover sleeve with respect to the base part. For example, the sleeve extension may be a fixed component of the cover sleeve. Thus, the sleeve extension can be taken into account when deep-drawing the cover sleeve and produced in the same working step. For example, the sleeve extension is designed in the shape of a triple-flat in its longitudinal cross-section to ensure that the stop sleeve is secured against rotation. Alternatively, however, any other suitable cross-sectional shape is conceivable that fulfills the function of the form-fit rotation-prevention.

According to a particularly preferred embodiment, the base element comprises guide means, wherein the guide means are configured to guide the lifting rod axially along a longitudinal contour. This has the technical advantage, for example, that a purely translatory movement of the lifting rod can be ensured. Due to the purely translatory movement of the lifting rod, no rotational decoupling between the valve body and the lifting rod is required. In addition, a sliding disk is no longer needed because the amount of wear is reduced due to the lack of relative movement between the components. Overall, the service life of the valve drive device and thus the service life of the entire valve is extended. In addition, contamination due to wear is avoided. For example, the guide means comprise a guide disk which is arranged within the base element and can be installed in a non-rotatable manner with respect to the base element. The lifting rod extends through the guide disk and the longitudinal contour of the lifting rod is located in a radially arranged guide notch of the guide disk. Alternatively, the guide notch can also be referred to as a guide tab.

According to an alternative of the present invention, the solution of the problem is defined by the features of claim 20. The alternative solution comprises a valve for blocking and/or controlling a flow of fluids. The valve comprises a valve body that is configured to be movable between a fully closed position and a fully open position within a valve housing. In addition, the valve comprises a valve drive device according to one of the preceding claims, wherein the position of the valve body is controllable by the lifting rod of the valve drive device.

The advantages of this alternative are comparable to those of the previous embodiment. In particular, the technical advantage is achieved that the lifting rod is configured to be movable exclusively in a translatory manner and completely without rotation, whereby it is no longer necessary to provide a rotational decoupling between the valve body and the lifting rod. Likewise, it does not require a sliding disk because the amount of wear is significantly reduced. Another advantage lies in the closed sleeve, which improves robustness and reduces the number of components. In other words, the service life of the valve can be extended.

Different valve types can be combined with the valve drive device according to the invention. For example, the valve can also comprise two closed end positions.

In an exemplary further embodiment, the valve comprises a sealing element. The sealing element can be arranged on and/or at least partially in the valve body. Preferably, the sealing element is configured to be brought into fluid-tight contact with a sealing seat of the valve housing. In particular, this can be the case when the valve body is in the fully closed position. For example, the sealing element can be a sealing ring. When the sealing element is in fluid-tight contact with the sealing seat, preferably no or at least only a negligible fluid flow is possible between the sealing element and the sealing seat. The valve, in particular the valve body, may also comprise several sealing elements.

A sealing element advantageously ensures that a fluid flow can be particularly effectively prevented when the valve body is in the fully closed position.

In a further exemplary embodiment of the valve, the valve housing comprises a first sealing seat and a second sealing seat, in particular a second sealing seat that is different from the first sealing seat. For example, the first sealing seat can be spaced apart from the second sealing seat in the axial direction with respect to the longitudinal axis of the valve. The first sealing seat and the second sealing seat are preferably arranged opposite one another. The two sealing seats can be identical or different in shape. Preferably, the valve body is movable between the first sealing seat and the second sealing seat, in particular it is movable back and forth.

One embodiment of the valve having a first sealing seat and a second sealing seat has the advantageous effect that the valve, in particular the valve body of the valve, is movable between two different fully closed positions, in particular between a first fully closed position and a second fully closed position. Preferably, the valve body can be placed in the fully open position between the two fully closed positions. This has the advantage that the valve can be designed as a 3/2-way valve.

In a further exemplary embodiment, the valve may comprise a spring element. Preferably, the spring element is a spiral spring. The spring element can be arranged between the lifting rod and the valve body in the axial direction with respect to the longitudinal axis. As a result, a spring force of the spring element can act on the lifting rod and/or the valve body.

The spring element has the advantageous effect that the valve body can be pushed and/or pulled into the fully closed position with a predefined force, in particular a predefined spring force of the spring element. Thereby, a particularly high sealing effect can be achieved.

Alternatively or additionally, the spring element can be arranged within a spring chamber of the valve body. The spring chamber may be a cavity within the valve body. The lifting rod preferably extends at least partially into the spring chamber of the valve body. Such a valve design advantageously allows the valve drive device and the valve to comprise a particularly compact design.

In a further advantageous development of the aforementioned valve design, the spring element is configured to press the valve body into the first sealing seat. The spring element is preferably also configured to press the valve body into the second sealing seat. Such a further development advantageously causes the valve body to always rest against the first or second sealing seat with a predefined force. Thus, an especially high sealing effect can be achieved. The stroke is terminated by reaching the end stop in the guide block. Depending on the level of tolerance, the spring is biased a little more or a little less, but the force level varies within a very small range. As a result, the closing force of the sealing seat is defined and varies only within very small limits.

In another exemplary embodiment, the valve comprises force transmission means. The force transmission means are preferably configured and/or arranged in such a way that the spring element is connected in a force-transmitting manner either to the lifting rod or to the valve body, depending on the position of the lifting rod. For example, the lifting rod can exert a compressive force on the spring element via the force transmission means when the lifting rod is in the first end position. When the lifting rod is in the second end position, the spring element can exert a compressive force on the valve body via the force transmission means. The force transmission means are preferably provided within the spring chamber of the valve body.

In a further development of the aforementioned embodiment, the valve can comprise several force transmission means, in particular two. For example, a first force transmission means can be provided at a first end of the spring element and a second force transmission means can be provided at a second end of the spring element. Both force transmission means can be arranged within the spring chamber of the valve body.

When the lifting rod is in the first end position, the lifting rod can exert a first compressive force on the spring element via the first force transmission means. This first compressive force preferably causes the spring element to exert a first spring force on the second force transmission means, which is transmitted to the valve body by the second force transmission means. Accordingly, the valve body then advantageously moves in the direction of the first compressive force.

When the lifting rod is in the second end position, the lifting rod can exert a second compressive force on the spring element via the second force transmission means. The second compressive force preferably acts in the opposite direction of the first compressive force. The second compressive force preferably causes the spring element to exert a second spring force, in the opposite direction of the first spring force, on the first force transmission means, which is transmitted to the valve body by the first force transmission means. Accordingly, the valve body then advantageously moves in the direction of the second compressive force.

An embodiment with one force transmission means ensures in particular that the control movement of the lifting rod can be transmitted particularly well, for example particularly evenly, to the spring element and/or that the spring element can transmit its spring force particularly well, for example particularly evenly, to the valve body. This has the advantage that the probability of the valve body jamming in the valve housing—and thus of unwanted wear or failure of the valve—can be greatly reduced.

According to a further alternative of the present invention, the solution of the problem is defined by the features of claim 21. This alternative solution comprises a method for manufacturing the valve drive device according to one of the preceding embodiments, wherein the method comprises the steps of arranging the stop sleeve on the lifting rod, arranging the driver in the guide track of the stop sleeve, placing the rotor on the stop sleeve and inserting the driver into the guiding element, and fastening the transmission device to the lifting rod.

The advantages of this alternative are comparable to those of the previous embodiments. Additionally, with regard to the manufacturing process, the technical advantage is achieved that the assembly and adjustability of the valve drive device is particularly simple and error-resistant. The components can be easily assembled as well as replaced depending on the application. For example, it may be useful to adjust the valve lift. For example, the first end stop and/or the second end stop can be easily changed by replacing the stop sleeve with a correspondingly designed guide track. For example, to replace a stop sleeve, only the transmission device needs to be removed from the lifting rod, the rotor needs to be removed from the stop sleeve, the driver needs to be removed from the guide track and the existing stop sleeve needs to be removed from the lifting rod. For example, according to an alternative embodiment, only the cover or the sleeve needs to be removed to replace the existing stop sleeve.

Subsequently, a new stop sleeve has to be mounted on the lifting rod, the driver has to be arranged in the guide track of the new stop sleeve and the corresponding components have to be reassembled depending on the embodiment.

According to an additional embodiment, the lifting rod is biased in the axial direction. This has the technical advantage, for example, that the stroke of the lifting rod can be adjusted in a particularly precise manner. Thus, for example, it can be ensured that the valve body presses against the sealing seat with a predefined force in the fully closed end position.

The following detailed description and the entirety of the patent claims provide further advantageous embodiments and feature combinations of the invention.

### BRIEF DESCRIPTION OF THE DRAWINGS

The various features described above as examples can be combined with each other in accordance with the invention, provided this is technically sensible and feasible. Further combinable features, advantages and embodiments of the invention can be found in the following description of the embodiments illustrated in the figures.

FIG. 1 illustrates a schematic sectional view of a valve according to the invention for blocking and/or controlling a flow of fluids.

FIG. 2 illustrates a schematic sectional view of a valve according to the invention for blocking and/or controlling a flow of fluids according to a further embodiment.

FIG. 3 illustrates a schematic sectional view of a valve according to the invention for blocking and/or controlling a flow of fluids according to an additional embodiment, and

FIG. 4 illustrates a schematic sectional view of a further embodiment of the valve for blocking and/or controlling a flow of fluids.

### WAYS OF CARRYING OUT THE INVENTION

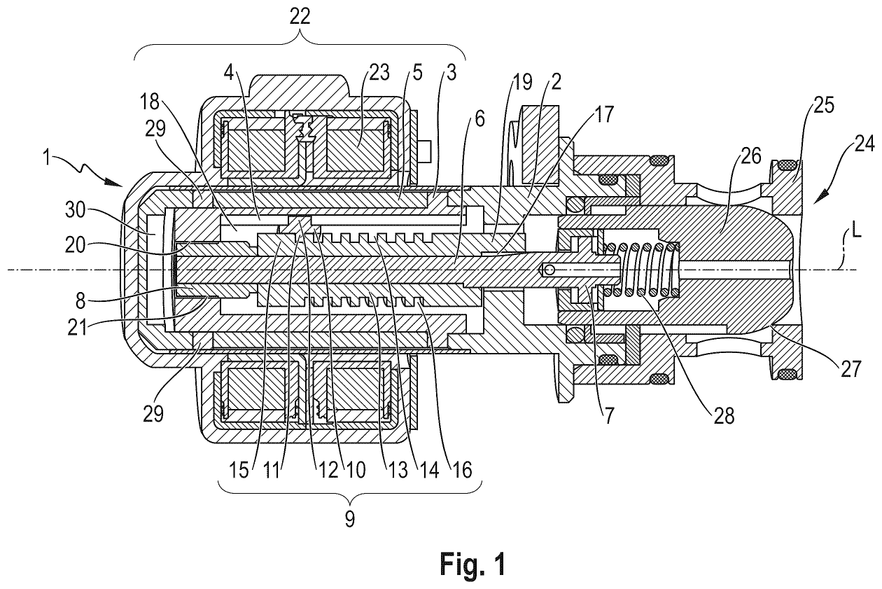

FIG. 1 shows a schematic sectional view of a valve 24 for blocking and/or controlling the flow of fluids according to the invention. The valve 24 comprises a valve body 26 that is configured to be movable between a fully closed position and a fully open position within a valve housing 25. Here, the valve body 26 is guided in a translatory manner between the fully closed position and the fully open position by a lifting rod 6. In the fully closed position, the valve body 26 contacts the sealing seat 27, whereby a fluid flow through the fluid housing 25 is not possible. In the fully open position, the valve body 26 is arranged away from the sealing seat 27, whereby a fluid flow through the fluid housing 25 is possible.

The valve body 26 is driven by means of the valve drive device 1. The valve drive device 1 comprises a base element 2 which, for example, is used to fasten the valve 24 in an installation space. For example, the base element 2 is made of a suitable metal, such as aluminum, or a strong plastic. A lifting rod 6 for transmitting the drive of the valve body 26 is mounted within the base element 2. With respect to the base element 2, the lifting rod 6 is movably mounted exclusively in a translatory manner along its longitudinal axis L. In other words, the lifting rod 6 is translatory movable between a first end position, in which the valve body 26 is completely removed from the sealing seat 27 and a maximum fluid flow is possible, and a second end position, in which the valve body 26 is completely in contact with the sealing seat 27 and no fluid flow is possible. The movement between the first end position and the second end position is completely without rotation and exclusively translatory.

A spring element 28 is located between a controlling end 7 of the lifting rod 6 and the valve body 26. The spring element 28 enables the valve body 26 to be pressed into the sealing seat 27 using a defined biasing force.

A rotor 3 rotatable about the longitudinal axis L is arranged around the lifting rod 6 and serves to drive the lifting rod 6. The rotor 3 comprises one or more permanent magnets 5 in its circumferential direction and is set into rotation by means of a stator 23. A transmission device 8 is arranged at an end of the lifting rod 6 opposite the controlling end 7. The transmission device 8 is firmly connected to the rotor 3 by means of an external thread 20 and serves to transmit the rotation of the rotor 3 to the lifting rod 6. By transmitting the rotation of the rotor 3 via the transmission device 8 to the lifting rod 6, the lifting rod 6 is moved exclusively in a translatory manner and without any rotational movement. This eliminates the need for a rotational decoupling between the lifting rod 6 and the valve body 26. In addition, no sliding disk is required because the amount of wear is significantly reduced by the purely translatory movement and there is no relative movement of the components to each other. A rotation-limiting device 9 is located in a cavity 18 of the rotor 3. The rotation-limiting device 9 serves to limit the rotational movement of the rotor 3 between a first end stop and a second end stop. In this case, the lifting rod 6 is in the fully open end position when the rotor 3 has turned into the first end stop. Correspondingly, the lifting rod 6 is in the fully closed end position when the rotor 3 has turned into the second end stop. The rotation-limiting device 9 is arranged at least in portions radially between the lifting rod 6 and the rotor 3. The rotation-limiting device 9 comprises a stop sleeve 13 and a driver 10. The driver 10 is arranged between the stop sleeve 13 and the rotor 3, wherein the driver 10 is connected to the rotor 3 in such a way that it is slidingly movable in the axial direction.

Consequently, a torque transmission from the rotor 3 to the driver 10 is possible. The stop sleeve 13 comprises a guide track 14 aligned in the radial direction for guiding the driver 10. Here, the driver 10 comprises a first projection 11, which engages in the guide track 14. Hence, a torque is transmitted from the stator 23 to the rotor 3 and thus directly to the driver 10, wherein the driver slides through the guide track 14 of the stop sleeve 13. Consequently, the rotational movement of the rotor 3 is transferred into a rotational movement of the driver 10 around the stop sleeve 13 and the driver 10 is moved within the guide track 14.

The axial movement of the lifting rod is effected by the transmission device 8, while the rotation-limiting device 9 together with the driver 10 and the stop sleeve 13 define the first end position and the second end position of the lifting rod 6, wherein the rotor 3 always remains in an axially unchanged position.

The guide track 14 has a first guide track end 15 and a second guide track end 16. The first guide track end 15 corresponds to the first end stop for the rotor 3. The second guide track guide track end 16 corresponds to the second end stop for the rotor 3. Thus, the fully extended position of the lifting rod 6 and consequently the fully closed valve position is defined by the specific arrangement of the first guide track end 15. The driver 10 slides through the guide track 14 of the stop sleeve 13 due to the rotation of the rotor 3 and collides with the first end of the guide track 15. This prevents the rotational movement of the rotor 3 from continuing. Similarly, the rotational movement of the rotor 3 in the opposite rotational direction is blocked when the driver 10 slides through the guide track 14 of the stop sleeve 13 and collides with the second guide track end 16. Hence, the fully retracted position of the lifting rod 6 and consequently the fully open valve position is defined by the specific arrangement of the second guide track end 16. When the first end stop is reached, the valve 24 is completely closed, whereby the valve body 26 is completely seated in the seal seat 27. When the second end stop is reached, the valve 24 is completely open and the lifting rod 6 cannot be retracted any further. The end stops each by means of a mechanical stop prevent any further axial movement of the lifting rod 6 despite applied torque.

The stop sleeve 13 is connected to the base element 2 in a rotationally fixed, respectively non-rotational, manner. This is achieved by means of a rotation prevention 17 between the lifting rod 6 and the stop sleeve 13. The rotation prevention 17 has a finger 19, which engages in an axial direction in a recess in the base element 2 for a precise fit. The lifting rod 6 and the stop sleeve 13 are connected to each other by a rotation prevention 17. Hence, the rotation prevention 17 is realized between the lifting rod 6 and the stop sleeve 13.

The rotor 3 comprises a guiding element 4 in the form of an axially aligned groove. The driver 10 is guided on the one hand radially on the inner side by means of the first projection 11 in the guide track 14 of the stop sleeve 13 and on the other hand radially on the outer side by means of the second projection 12 in the guiding element 4 of the rotor 3. Thus, the driver 10 is movable relative to the rotor 3 exclusively in the longitudinal direction, whereby only a torque transmission from the rotor 3 to the driver 10 is possible.

Due to the rotation-limiting device 9, there is no axial movement of the rotor 3 in relation to the stator 2, while the valve drive device 1 moves between the first end stop and the second end stop. Thus, an improved torque transmission between stator 23 and rotor 3 is realized, whereby a particularly compact design of the valve drive device 1 is possible.

In an axial direction, a loose bearing element 29 is located between the permanent magnet 5 of the rotor 3 and the cover element 30. The bearing element 29 is designed in the circumferential direction and, on the one hand, has a bearing function between the rotor 3 and the cover element 30. On the other hand, the loose bearing element 29 is configured to compensate for length expansions of the rotor due to temperature differences. If, for example, no different length expansions are absorbed, the bearing element can also be designed as an integral part of the rotor.

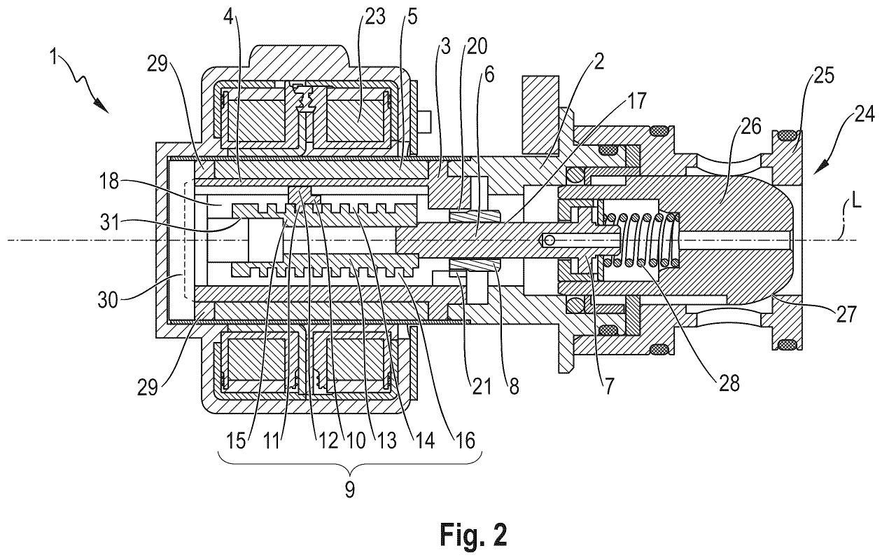

FIG. 2 shows a schematic sectional view of a valve according to the invention for blocking and/or controlling the flow of fluids according to a further embodiment. As in the previous embodiment, the valve 24 comprises a valve body 26 that is configured to be movable within a valve housing 25 between a fully closed position and a fully open position. Also in this embodiment, the valve body 26 is guided back and forth in a translatory manner between the fully closed position and the fully open position by a lifting rod 6. In the fully closed position, the valve body 26 is in contact with the sealing seat 27, preventing fluid flow through the fluid housing 25. In the fully open position, the valve body 26 is moved away from the sealing seat 27, allowing fluid flow through the fluid housing 25.

The drive of the valve body 26 is achieved by means of the valve drive device 1 comprising a base element 2. A lifting rod 6 for transmitting the drive of the valve body 26 is mounted within the base element 2. The lifting rod 6 is mounted with respect to the base element 2 such that it can move in a purely translatory manner along its longitudinal axis L. Thus, the lifting rod 6 is translatory movable between a first end position, in which the valve body 26 is completely removed from the sealing seat 27 and a maximum fluid flow is possible, and a second end position, in which the valve body 26 is seated completely against the sealing seat 27 and no fluid flow is possible. In this embodiment, the movement between the first end position and the second end position is also completely free of rotation and exclusively translatory.

A spring element 28 is located between a controlling end 7 of the lifting rod 6 and the valve body 26. The spring element 28 enables the valve body 26 to be pressed into the sealing seat 27 with a defined biasing force.

A rotor 3 rotatable around the longitudinal axis L is arranged around the lifting rod 6 and serves to drive the lifting rod 6. The rotor 3 comprises one or more permanent magnets 5 in its circumferential direction and is set in rotation by means of a stator 23.

A transmission device 8 is located between the controlling end 7 of the lifting rod 6 and an end of the lifting rod 6 opposite the controlling end 7. The transmission device 8 is located directly between an end of the rotor 3 assigned to the base element 2 and the base element 2 itself. In this case, the lifting rod 6 extends only partially into the stop sleeve 13. The transmission device 8 is firmly connected to the rotor 3 by means of an external thread 20 and serves to transmit the rotation of the rotor 3 to the lifting rod 6. As a result of the transmission of the rotation of the rotor 3 to the lifting rod 6 via the transmission device 8, the lifting rod 6 is moved exclusively in a translatory manner and without any rotational component of movement. Hence, it is not necessary to arrange a rotational decoupling between the lifting rod 6 and the valve body 26. In addition, a sliding disk is not required because the amount of wear is significantly reduced by the purely translatory motion and there is no relative movement between the components.

In contrast to the first embodiment, the lifting rod 6 is designed to be significantly shorter, whereby the entire valve drive device 1 can be designed to be more compact in the longitudinal direction. Here, the lifting rod 6 is only mounted via the controlling end 7, whereby the manufacturing costs and the tolerance requirements can be reduced.

A rotation-limiting device 9 is located in a cavity 18 of the rotor 3. The rotation-limiting device 9 serves to limit the rotational movement of the rotor 3 between a first end stop and a second end stop and works in a functionally identical manner to that of the first embodiment in FIG. 1. Here, the lifting rod 6 is in the fully open end position when the rotor 3 has turned into the first end stop. Correspondingly, the lifting rod 6 is in the fully closed end position when the rotor 3 has turned into the second end stop. The rotation-limiting device 9 is arranged completely radially within the rotor 3. The rotation-limiting device 9 comprises a stop sleeve 13 and a driver 10. The driver 10 is arranged between the stop sleeve 13 and the rotor 3, wherein the driver 10 is connected to the rotor 3 in a slidingly movable manner in the axial direction.

Hence, also in this embodiment, a torque transmission from the rotor 3 to the driver 10 is possible. The stop sleeve 13 comprises a guide track 14 aligned in the radial direction for guiding the driver 10. The driver 10 comprises a first projection 11, which engages in the guide track 14. Hence, a torque is transmitted from the stator 23 to the rotor 3 and thus directly to the driver 10, with the driver 10 sliding through the guide track 14 of the stop sleeve 13. Consequently, the rotational movement of the rotor 3 is transferred into a rotational movement of the driver 10 around the stop sleeve 13 and the driver 10 is moved within the guide track 14.

A repeated description of the rotation-limiting device is omitted and complete reference is made to the description of FIG. 1.

On one side of the rotor 3 opposite the transmission device 8, the valve drive device 1 comprises a cover element 30, which is connected to the stop sleeve 13 in a rotationally fixed manner via an engaging portion 31. The stop sleeve 13 is thereby connected to the cover element 30 in a rotationally fixed manner. The engaging portion 31 is configured to be movable in the longitudinal direction, whereby tolerance compensation is possible in the longitudinal direction. For example, the engaging portion 31 can be realized by means of a torque-transmitting plug connection to the cover element 30.

In an axial direction, a bearing element 29 is located between the rotor 3 and the cover element 30. The bearing element 29 is formed in the circumferential direction and, on the one hand, has a bearing function between the rotor 3 and the cover element 30. On the other hand, the bearing element 29 is configured to compensate for material stresses due to temperature differences.

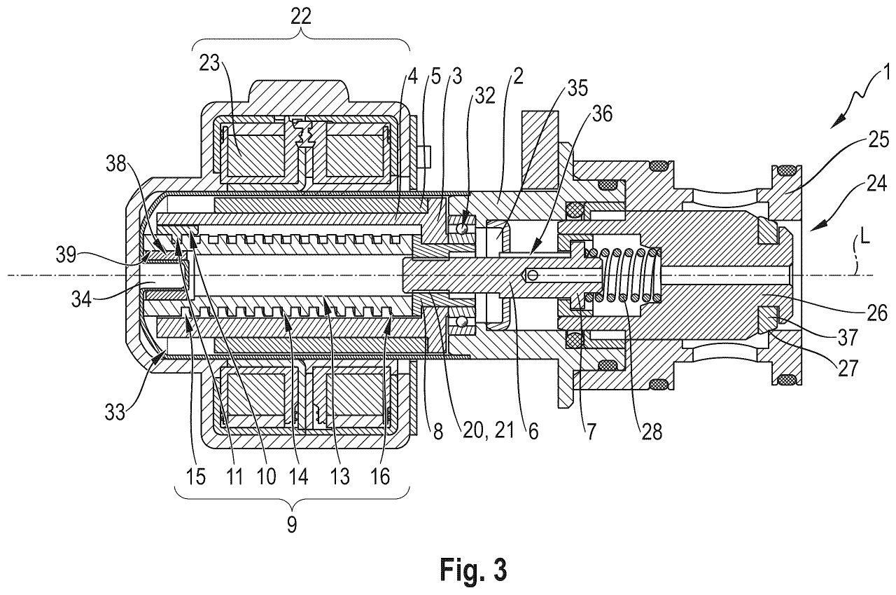

FIG. 3 shows a schematic sectional view of a valve 24 according to the invention for blocking and/or controlling the flow of fluids according to an additional embodiment. As in the previous embodiments, the valve 24 comprises a valve body 26 that is configured to be movable within a valve housing 25 between a fully closed position and a fully open position. Also in this embodiment, the valve body 26 is guided back and forth in a translatory manner between the fully closed position and the fully open position by a lifting rod 6. In the fully closed position, the valve body 26 rests against the sealing seat 27, whereby a fluid flow through the fluid housing 25 is not possible. The valve body 26 has an annular sealing element 37, which provides an improved seal between the valve body 26 and the sealing seat 27, thus meeting higher leakage requirements. In the fully open position, the valve body 26 is moved away from the sealing seat 27, allowing fluid flow through the fluid housing 25.

In this embodiment, the valve body 26 is also driven by means of the valve drive device 1 comprising a base element 2. A lifting rod 6 for transmitting the drive of the valve body 26 is mounted within the base element 2. With respect to the base element 2, the lifting rod 6 is movable in an exclusively translatory manner along its longitudinal axis L. Guide means 35 in the form of a guide disk are arranged within the base element 2. The lifting rod 6 extends through the guide disk, wherein a longitudinal contour 36 is arranged on the lifting rod 6. The longitudinal contour 36 lies in a radially arranged guide notch or guide tab of the guide disk. Thus, the lifting rod 6 is movable in a purely translatory manner between a first end position, in which the valve body 26 is completely removed from the sealing seat 27 and a maximum fluid flow is possible, and a second end position, in which the valve body 26 is seated completely against the sealing seat 27 and no fluid flow is possible. In this embodiment, the movement between the first end position and the second end position is also completely free of rotation and exclusively translatory.

A spring element 28 is located between the controlling end 7 of the lifting rod 6 and the valve body 26. The spring element 28 enables the valve body 26 to be pressed into the sealing seat 27 with a defined biasing force. A rotor 3, rotatable around the longitudinal axis L, is located coaxially to the lifting rod 6 and serves to drive the lifting rod 6. The rotor 3 comprises one or more permanent magnets 5 in its circumferential direction and is caused to rotate by means of a stator 23.

A transmission device 8 is located at an end of the lifting rod 6 that is opposite the controlling end 7 of the lifting rod 6. The transmission device 8 is designed as a metallic component, with the rotor 3 being directly connected to the transmission device 8. A roller bearing 32 for mounting the rotor 3 relative to the base part 2 is arranged between a flange-like extension of the transmission device 8 and the base element 2. The transmission device 8 thus has a dual function. On the one hand, the transmission device 8 converts a rotational movement of the rotor 3 into a translational movement of the lifting rod 6. On the other hand, the transmission device 8 supports the rotor 3 on the base element 2 by means of a roller bearing 32. The bearing occurs both radially and radially.

In contrast to the first two embodiments, the lifting rod 6 is designed to be shorter, whereby the entire valve drive device 1 can be designed to be even more compact in the longitudinal direction. The lifting rod 6 is mounted only via the controlling end 7, whereby the manufacturing costs and the tolerance specifications can be reduced.

A rotation-limiting device 9 is located inside the rotor 3. The rotation-limiting device 9 serves to limit the rotational movement of the rotor 3 between a first end stop and a second end stop and works in the same way as in the first two embodiments in FIG. 1 and FIG. 2. Here, the lifting rod 6 is in the fully open end position when the rotor 3 has turned into the first end stop. Correspondingly, the lifting rod 6 is in the fully closed end position when the rotor 3 has turned into the second end stop. The rotation-limiting device 9 is arranged completely radially within the rotor 3. The rotation-limiting device 9 comprises a stop sleeve 13 and a driver 10. The driver 10 is arranged between the stop sleeve 13 and the rotor 3, wherein the driver 10 is connected to the rotor 3 in a slidingly movable manner in the axial direction.

Consequently, torque transmission from the rotor 3 to the driver 10 is also possible in this embodiment. The stop sleeve 13 comprises a guide track 14 aligned in the radial direction for guiding the driver 10. Here, the driver 10 comprises a first projection 11, which engages in the guide track 14. Consequently, a torque is transmitted from the stator 23 to the rotor 3 and thus directly to the driver 10, with the driver 10 sliding through the guide track 14 of the stop sleeve 13. The rotational movement of the rotor 3 is converted into a rotational movement of the driver around the stop sleeve 13 and the driver 10 is moved within the guide track 14.

A repeated description of the rotation-limiting device is omitted and complete reference is made to the description of FIG. 1 and FIG. 2.

The rotor 3, the permanent magnets 5, the rotation-limiting device 9 and the transmission device 8 are located within a cover sleeve 33. The cover sleeve 33 is preferably manufactured by a deep-drawing process. The cover sleeve 33 is firmly connected to the base element 2 and comprises an internal sleeve extension 34 at an end opposite the base element 2. The sleeve extension 34 engages axially in the stop sleeve 13, thereby preventing the stop sleeve 13 from rotating in relation to the cover sleeve 33 and thus in relation to the base element 2.

An adapter 38 can be arranged between the sleeve extension 34 and the stop sleeve 13. The adapter 38 has teeth arranged radially on the outside, which allows the adapter 38 to engage easily in the internal tooth contour 39 of the stop sleeve 13. In the present embodiment, the form fit between the adapter 38 and the stop sleeve 13 is realized by means of 60 teeth arranged in the circumferential direction. Alternatively, fewer or more teeth can be used. With the help of the adapter 38 and the internal tooth contour 39 of the stop sleeve, the valve control device 1 can be mounted particularly easily and the end stop can be precisely adjusted in relation to the valve seat, wherein in particular the components within the cover sleeve 33 can be easily inserted and precisely arranged.

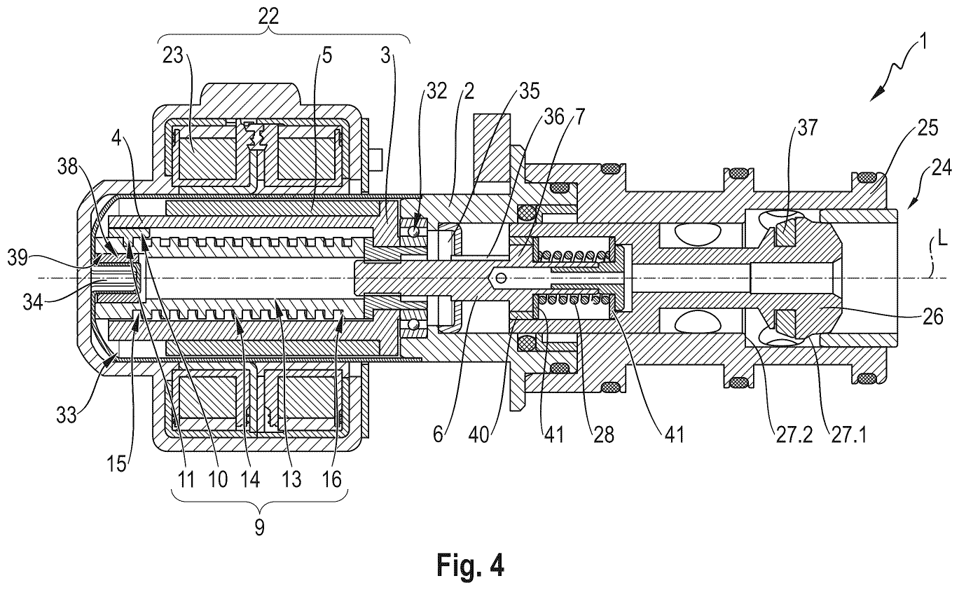

FIG. 4 shows a schematic sectional view of a further embodiment of a valve 24 for blocking and/or controlling the flow of fluids. The valve drive device 1 of the valve 24 shown in FIG. 4 is designed in the same way as the valve drive device 1 of the valve 24 shown in FIG. 3.

In contrast to the valve 24 shown in FIG. 3, the valve 24 shown in FIG. 4, in particular the valve body 26 of the valve 24 shown in FIG. 4, comprises two sealing seats 27, namely a first sealing seat 27.1 and a second sealing seat 27.2. Also in the position shown in FIG. 4, the lifting rod 6 is in the second end position. This can be seen from the fact that the valve body 26 is completely shifted to the right and rests in a fluid-tight manner against the first sealing seat 27.1. In other words, in the representation of FIG. 4, the valve body 26 is in a first completely closed position.

When the valve drive device 1 drives the valve 24, in particular the valve body 26, the lifting rod 6 is moved from the second end position shown in FIG. 4 to the first end position. For this purpose, the lifting rod 6 moves in the axial direction to the left with respect to the longitudinal axis L. This movement of the lifting rod 6 causes the valve body 26 to also be moved in the axial direction to the left with respect to the longitudinal axis L. The valve body 26 moves to the left until the valve body 26 engages with its sealing element 37 on the second sealing seat 27.2 respectively until it is in fluid-tight contact with the second sealing seat 27.2. The valve body 26 is then in a second fully closed position.

Together with a supporting ring 40, the valve body 26 forms a cavity 42, which will also be referred to below as the spring chamber 42. The supporting ring 40 is configured in such a way that it comprises a passage for the lifting rod 6. In other words, the lifting rod 6 extends through the passage in the supporting ring 40 in such a way that the lifting rod 6 projects into the spring chamber 42.

A spring element 28 is provided within the spring chamber 42. The spring element 28 is arranged in the axial direction between the lifting rod 6 and the valve body 2. The left end of the spring element 28 is supported on left force transmission means 41, in particular on first force transmission means 41. The right end of the spring element 28 is supported on right force transmission means 41, in particular on second force transmission means 41.

In the position shown in FIG. 4, the lifting rod 6 presses with its controlling end 7 on the left force transmission means 41 in such a way that the left force transmission means 41 is pushed to the right. This causes the spring element 28 to be compressed to the right. The resulting spring force of the spring element 28 in turn presses the right force transmission means 41 against the valve body 26. Consequently, the valve body 26 is pressed against the first sealing seat 27.1 with the spring force of the spring element 28. When the lifting rod 6 moves to the left, starting from the position shown in FIG. 4, the lifting rod 6 will push the right force transmission means 41 to the left with its right end. This causes the spring element 28 to be compressed to the left. The resulting spring force of the spring element 28 in turn pushes the left force transmission means 41 to the left. However, since the left force transmission means 41 can no longer be supported on the controlling end 7 of the lifting rod 6 (the controlling end 7 has then moved with the lifting rod 6 to the left), the left force transmission means 41 is pressed against the supporting ring 40. The supporting ring 40 is in turn firmly connected to the valve body 26. Consequently, the valve body 26 is moved to the left by the spring force of the spring element 28 until the valve body 26 is pressed against the second sealing seat 27.2. The stroke is terminated by reaching the end stop in the guide block. Depending on the level of tolerance, the spring is biased slightly more or less, but the force level varies within a very small range. The closing force of the seal seat is defined and varies only within very small limits.

List of reference signs

| | |
|---|---|
| 1 | valve drive device |
| 2 | base element |
| 3 | rotor |
| 4 | guiding element/guiding groove |
| 5 | permanent magnet |
| 6 | lifting rod |
| 7 | controlling end |
| 8 | transmission device |
| 9 | rotation-limiting device |
| 10 | driver |
| 11 | first projection of the driver |
| 12 | second projection of the driver |
| 13 | stop sleeve |
| 14 | guide track |
| 15 | first guide track end |
| 16 | second guide track end |
| 17 | rotation prevention between lifting rod and stop sleeve |
| 18 | cavity |
| 19 | finger |
| 20 | external thread of the transmission device |
| 21 | internal thread |
| 22 | stepper motor |
| 23 | stator |
| 24 | valve |
| 25 | valve housing |
| 26 | valve body |
| 27 | sealing seat |
| 27.1 | first sealing seat |
| 27.2 | second sealing seat |
| 28 | spring element |
| 29 | bearing element |
| 30 | cover element |
| 31 | engaging portion |
| 32 | roller bearing |
| 33 | cover sleeve |
| 34 | sleeve extension |
| 35 | guide means |
| 36 | longitudinal contour |
| 37 | sealing element |
| 38 | adapter |
| 39 | tooth contour |
| 40 | supporting ring |
| 41 | force transmission means |
| 42 | spring chamber |
| D | rotation axis of the rotor |
| L | longitudinal axis of the control piston |

1. A valve drive device comprising:
a base element;
a lifting rod for driving a valve body, the lifting rod being movable in terms of translation and without rotation along a longitudinal axis thereof with respect to the base element between a first end position and a second end position different from the first end position;
a rotor rotatable about the longitudinal axis for driving the lifting rod, wherein a rotational movement of the rotor is transmittable by a transmission device into the translatory and non-rotational movement of the lifting rod; and
a rotation-limiting device for limiting the rotational movement of the rotor between a first end stop and a second end stop, wherein
the lifting rod is in the first end position when the rotor has rotated into the first end stop, and the lifting rod is in the second end position when the rotor has rotated into the second end stop.

2. The valve drive device according to claim 1, wherein the rotation-limiting device is arranged, at least in portions, radially between the lifting rod and the rotor.

3. The valve drive device according to claim 1, wherein the rotation-limiting device comprises a stop sleeve and a driver, wherein the driver is arranged between the stop sleeve and the rotor, and
wherein the driver is connected to the rotor in a rotationally fixed and slidably movable manner, and wherein the stop sleeve comprises a guide track for guiding the driver.

4. The valve drive device according to claim 3, wherein a rotational movement of the rotor causes a rotational movement of the driver around the stop sleeve and the driver is moved within the guide track.

5. The valve drive device according to claim 3, wherein the guide track is configured as a helical groove in the stop sleeve and
wherein the driver comprises a first projection arranged to engage in a helical groove of the stop sleeve.

6. The valve drive device according to claim 3, wherein the guide track has a first guide track end and a second guide track end, the first guide track end defining the first end stop for the rotor and the second guide track end defining the second end stop for the rotor.

7. The valve drive device according to claim 3, wherein the stop sleeve is connected in a rotationally fixed manner to the base element.

8. The valve drive device according to claim 3, wherein the lifting rod is arranged in the base element in a rotationally fixed and slidingly movable manner.

9. The valve drive device according to claim 3, wherein the rotor comprises a guiding element, wherein the driver is connected to the rotor via the guiding element in a rotationally fixed and slidingly movable manner.

10. The valve drive device according to claim 1, wherein, in the longitudinal direction, the lifting rod comprises a controlling end for controlling the valve body and the transmission device is arranged at an end of the lifting rod opposite to the controlling end.

11. The valve drive device according to claim 1, wherein the lifting rod is mounted such that the lifting rod can be biased with respect to a valve body to be controlled.

12. The valve drive device according to claim 1, wherein the valve drive device comprises a stepper motor, wherein the stepper motor comprises a stator and the rotor, and the stator, at least in portions, encases the rotor and the rotational movement of the rotor is controllable via the stator.

13. The valve drive device according to claim 12, wherein an axial orientation of the stator with respect to the rotor during a rotational movement of the rotor between the first end stop and the second end stop is configured to be invariable.

14. The valve drive device according to claim 1, wherein, in the longitudinal direction, the lifting rod comprises a controlling end for controlling the valve body and the transmission device is arranged between the controlling end and the stop sleeve.

15. The valve drive device according to claim 14, wherein the valve drive device comprises a cover element connected to the stop sleeve in a rotationally fixed manner by an engaging portion.

16. The valve drive device according to claim 1, wherein the rotor is mounted on the base element via a roller bearing.

17. The valve drive device according to claim 1, wherein the valve drive device comprises a deep-drawn cover sleeve firmly connected to the base element, and wherein the rotor and the rotation-limiting device are completely housed in the cover sleeve.

18. The valve drive device according to claim 17, wherein the cover sleeve comprises a sleeve extension for engagement in the stop sleeve, and
wherein the sleeve extension is configured to fix the stop sleeve with respect to the cover sleeve at least in a rotationally fixed manner.

19. The valve drive device according to claim 1, wherein the base element comprises guide means, and
wherein the guide means are configured to guide the lifting rod axially along a longitudinal contour.

20. A valve for blocking and/or controlling a flow of fluids, the valve comprising:
a valve body configured to be moved between a fully closed position and a fully open position within a valve housing, and
a valve drive device according to claim 1, wherein the position of the valve body is controllable by the lifting rod of the valve drive device.

21. The valve according to claim 20, wherein the valve body comprises at least one sealing element, and wherein the sealing element is configured to rest in a fluid-tight manner on a sealing seat of the valve housing when the valve body is in the fully closed position.

22. The valve according to claim 20, wherein the valve housing comprises a first sealing seat and a second sealing seat, and the valve body is movable back and forth between the first sealing seat and the second sealing seat.

23. The valve according to claim 20, wherein the valve comprises a spring element, and wherein the spring element is arranged an axial direction with respect to the longitudinal axis between the lifting rod and the valve body.

24. The valve according to claim 23,
wherein the valve housing comprises a first sealing seat and a second sealing seat, and the valve body is movable back and forth between the first sealing seat and the second sealing seat, and
wherein the spring element is configured to press the valve body into the first sealing seat and/or the second sealing seat.

25. The valve according to claim 23, wherein the spring element is connected, via force transmission means and in dependence on the position of the lifting rod, in a force-transmitting manner either to the lifting rod or to the valve body.

26. A method for manufacturing the valve drive device according to claim 1, the method comprising the following steps:
arranging the stop sleeve on the lifting rod,
arranging the driver in the guide track of the stop sleeve 1,
placing the rotor on the stop sleeve and inserting the driver into the guiding element, and
fastening the transmission device to the lifting rod.

27. The method of claim 26, wherein the lifting rod
is biased in an axial direction.
